(19) United States
(12) Patent Application Publication
(10) Pub. No.: US 2025/0180765 A1
(43) Pub. Date: Jun. 5, 2025

(54) NEUTRON DETECTOR COMPRISING AN OPTICAL FISSION CHAMBER WITH A REFLECTIVE OPTICAL CAVITY AND A DETECTION HEAD COUPLED TO THE CHAMBER COMPRISING AN OPTICAL LENS AND A FIBRE-OPTIC COUPLER

(71) Applicant: Commissariat A L'Energie Atomique Et Aux Energies Alternatives, Paris (FR)

(72) Inventors: Marc POURADIER-DUTEIL, Saint Paul Lez Durance (FR); Christian Jammes, Saint Paul Lez Durance (FR)

(21) Appl. No.: 18/965,413

(22) Filed: Dec. 2, 2024

(30) Foreign Application Priority Data
Dec. 5, 2023 (FR) 2313549

(51) Int. Cl. G01T 3/00; G21C 17/06; G21C 17/108

(52) U.S. Cl. CPC G01T 3/008; G21C 17/06; G21C 17/108

(57) ABSTRACT

Neutron detector comprising an optical fission chamber with a reflective optical cavity and a detection head coupled to the chamber comprising an optical lens and a fibre-optic coupler. A neutron detector including at least one seal-tight ionization chamber referred to as an OFC, acronym of optical fission chamber, each chamber implementing optical transduction and comprising an optical cavity the operation of which is based on optical transduction and which incorporates, at one of its longitudinal ends, a window and an optical lens by way of optical interface and, at the other end, a mirror for reflecting photons travelling away from the window.

### TECHNICAL FIELD

The present invention relates to the field of instrumentation, in particular for nuclear fission and fusion reactors.

It relates more particularly to fission-chamber neutron detectors and more particularly to so-called optical fission chambers, i.e. fission chambers that involve transducing the neutron signal into an optical signal.

The aim of the invention is to provide such an optical fission chamber the signal-to-noise ratio of the neutron flux measurements of which is improved.

### BACKGROUND

Running a reactor, whether for power or research, entails strict requirements in terms of tracking multiple operating parameters.

Among these, the thermal power generated is one of the key parameters. This is directly correlated with the neutron flux close to or within the vessel. Thus, increasing the neutron flux results in an increase in the reactor's power level.

Various techniques for measuring the neutron flux exist, and they are grouped together under the umbrella of neutron detectors.

A plurality of neutron detectors may be installed in a nuclear reactor.

These detectors may be classified into two categories: active detectors, i.e. those the detection zone of which requires a bias voltage to collect and transmit information associated with detection of a neutron, and passive detectors for which the detection zone does not require any bias voltage.

For neutron measurements within a nuclear reactor, the active neutron detectors normally used are fission chambers or boron-deposit chambers which conventionally operate on the principle of transduction of a neutron flux into an electrical signal. This electrical transduction is performed by means of a pair of electrodes biased at a few hundred volts.

FIG. 1 shows a fission or boron-deposit chamber 1. This chamber 1 is bounded by an electrically conductive hollow cylinder 10, which is closed in seal-tight manner at its ends, and which forms a cathode, and on the central axis X of which lies a cylinder 11 of smaller diameter, forming an anode. The periphery of the anode 11 is coated with a deposit 12 of a material that strongly interacts with neutrons, such as uranium-235 or boron-10. The chamber 1 is furthermore filled with a gas. The interaction of the neutrons with the deposit 12 releases heavy charged particles into the gas of the chamber, which transfer their energy to the gas. These particles are slowed down by ionization of the atoms of the gas filling the chamber. Under the effect of the electric field generated by biasing the chamber, the electrons will move in the direction of the anode 11, i.e. the positive potential of the chamber. This collection of charge generates an electrical signal from which the measurement of the neutron flux may be deduced.

In this type of fission chamber 1, an accidental situation of loss of the bias of the chamber therefore leads to a loss of the measurement of neutron flux.

Also, for measurements in reactors, the only passive detector currently used in the industry is a type of detector called a collectron or self-powered neutron detector (SPND). In a collectron, an electron-emitting material (β⁻ decay) generates a current that is transmitted by a cable to a measuring device. Apart from the fact that certain types of collectrons require stabilization of the emitter, which may take up to 30 min, the transport of low currents over long distances remains an issue. Specifically, as is also the case for fission chambers, the signal must usually be transported through zones where electromagnetic interference (due to pumps, magnets, motors, etc.) is liable to occur.

To obtain a usable signal, electromagnetic shielding of the transmission line is necessary. This implies use of high-immunity cables, which are bulky, thereby generating a space constraint.

Whether for reasons of safety or space, the neutron detectors currently employed to measure neutron flux, in particular within a reactor, are therefore unsatisfactory.

A new avenue that represents a break from electrical transduction has been proposed: see for example publications [1] to [5] and patent FR3125135B1. In principle it consists in performing optical transduction, through collection of the photons produced in a chamber (designated the ionization chamber below) in which ionization occurs.

These fission chambers, which are called OFCs, acronym of optical fission chambers, are passive detectors that make it possible to overcome the problems of dependence on an electrical power supply and of the aforementioned bulkiness of the electrical cables transporting the signal.

An OFC therefore implements a transduction of the neutron signal into an optical signal. Specifically, when a gas is ionized by a heavy ion arising from the reaction between a neutron and an active material, such as a fissile material (boron, uranium), an electron shower takes place and leads to excitation, and then de-excitation, in a wide spectral range from the ultraviolet to the mid-infrared. This effect is schematically shown in FIG. 2.

This luminescence produced is then collected by means of an optical fibre designed to withstand radiation, which effectively limits the spectral region to be used. Specifically, it has been shown that silica optical fibres with a pure SiO2 core withstand radiation well and attenuate very little, typically a few dB/km, an optical signal the wavelength of which is in the near-infrared, typically between 800 and 1000 nm: see [5].

As for the transduction of the optical signal into an electrical signal, this is carried out outside the vessel of a nuclear reactor by means of one or more transducers such as photodiodes, silicon-based photomultipliers, or cameras.

These one or more transducers or detecting modules therefore convert the light signal into an electrical pulse, from which the measurement of the neutron flux is deduced. All of the components of an OFC-based measurement system are described below.

Table 1 below allows a comparison between fission chambers and state-of-the-art optical fission chambers (OFCs), according to various criteria.

TABLE 1

| Types of detectors | Fission chamber | Optical fission chamber |
|---|---|---|
| Passive | no | yes |
| Temperature resistance | up to 600° C. | up to 1000° C. |
| Footprint (cable | several tens of mm | hundreds of um |
| diameter) | | |
| Immunity to | depends on cable | yes |
| electromagnetic noise | diameter | |
| Accuracy of the | good | bad |
| measurement of neutron | | |
| flux | | |

It should be clear from Table 1 that improving the accuracy of the measurement of neutron flux is key to unlocking the potential of OFCs (optical fission chambers).

An important feature of OFCs is their signal-to-noise ratio: the higher this ratio, the more accurate the measurement.

Various studies have investigated the mechanisms responsible for signal and noise intensity, for measurements of neutron flux by an optical fission chamber within a nuclear reactor.

As regards signal intensity, for a given fission-chamber geometry, photon-collection efficiency, i.e. the number of photons collected by the fibre divided by the number of de-excitation photons emitted, is given by Equation 1 below:

$${η}_{vol} = π {r}_{chamber}^{2} {\int }_{- {θ}_{max}}^{{θ}_{max}} g ( θ ) d θ \times {\int }_{0}^{{r}_{fibre}} 2 π rf ( r ) dr \qquad [ Equation 1 ]$$

in which:
r_{chamber} is the inside radius of the chamber,
r_{fibre} is the radius of the fibre,
Θₘₐₓ is the maximum angle at which light is able to be transmitted to the fibre, and
g(Θ) and f(r) denote (in cm²) computed angular and radial distributions on the surface opposite the fibre, respectively.

Since the function f(r) is practically constant over the radius of the fibre, the collection efficiency is proportional to the square of the radius of the fibre. Based on this principle, a number of authors have suggested increasing the radius of the fibre in order to increase collection efficiency and therefore the accuracy of an OFC: [6], [7].

In fact, the flux of γ radiation present during a measurement in a reactor makes this solution of increasing the fibre radius unsatisfactory, as noise is also proportional to the radius of the fibre.

Specifically, because of the ionization induced in the fibre by the γ radiation of the reactor, electrons are emitted at a speed greater than c/n, c being the speed of light, i.e. the speed of propagation of electromagnetic waves, and n the refractive index of the fibre.

The movement of these electrons within the fibre generates emission of visible electromagnetic radiation, called Cherenkov radiation. This parasitic light is superimposed on the collected optical signal, this increasing noise and greatly degrading the signal-to-noise ratio.

The inventor has carried out studies and measurements that have shown that this Cherenkov radiation is the main source of noise in an optical fission chamber (OFC).

Specifically, the Franck-Tamm formula shows that, to a first approximation, the intensity of the Cherenkov radiation varies according to Equation 2 below.

$${I}_{Tcherenkov} ∝ {r}_{fibre}^{2} {L}_{irrad} . \qquad [ Equation 2 ]$$

in which:
r_{fibre} is the diameter of the fibre, and
L_{irrad} is the length of fibre irradiated.

In a reactor measurement, during which the optical fibre is subjected to ionizing radiation, both signal and noise being proportional to the square of the radius of the fibre, the signal-to-noise ratio does not depend on the fibre radius.

To nonetheless increase the signal-to-noise ratio of an optical fission chamber, the authors of publication [6] suggest using a reflective mirror in short optical cavities and lenses in long optical cavities, in order to compensate for the loss of efficiency due to the decrease in solid angle.

In addition, FIG. 9 of [6] suggests using optical fibres of higher numerical aperture to increase collection efficiency.

Considering the Cherenkov effect in the approach to optimization of the signal-to-noise ratio, the inventor believes that this solution is irrelevant. Specifically, if the suggestions of [6] are followed, the fraction of Cherenkov photons guided by the optical fibre is also greater: reference may be made to FIG. 3, which is taken from publication [8].

Consequently, the ways, suggested up to now, of improving the accuracy of measurement of neutron flux by means of an optical fission chamber (OFC) all lead to a dead-end insofar as although they increase the intensity of the signal they also increase optical or Cherenkov noise.

There is therefore a need to improve optical fission chambers (OFCs) allowing a measurement of neutron flux to be carried out, in particular within a nuclear reactor, in order either to increase the intensity of their measurement signal without increasing noise, or to increase the intensity of the measurement signal and decrease noise.

The aim of the invention is to at least partially meet this need.

### SUMMARY OF THE INVENTION

To do this, one subject of the invention is a neutron detector comprising:
at least one seal-tight ionization chamber in which optical transduction occurs, which chamber is called an optical fission chamber (OFC), each chamber extending along a longitudinal axis (X) and comprising:
   a seal-tight hollow body bounding internally an optical cavity and comprising at least one inner wall coated at least partially with at least one layer of fissile material, the optical cavity being filled with a gas, which is preferably under pressure, and which is capable of being ionized by an ion resulting from a reaction between a neutron and the fissile material,
   a window, arranged at one of the longitudinal ends of the hollow body and configured to seal the optical cavity,
   an optical lens, fastened by bonding to or integrally formed with the window, the optical lens being configured to focus photons received by the window,
   a mirror, arranged at the other of the longitudinal ends of the hollow body, which end is opposite the longitudinal end where the window is arranged, the mirror being configured to reflect photons towards the window,
a detection head comprising a fibre-optic coupler comprising a plurality of optical fibres by way of inputs, said optical fibres being arranged in the focal plane of the lens, and one optical fibre by way of output, in which optical fibre the optical signals received by the inputs are summed.

Advantageously, the OFC is axisymmetric in shape and has a central axis (X). Thus, the hollow body of the OFC is preferably a cylinder, a sphere or a cone.

Advantageously, the surface density ρₘₐₓ of the fissile material is less than or equal to 2 mg/cm². The surface area of the hollow body is increased as the mass of fissile material to be deposited is increased. To maximize the energy deposited in the gas, the diameter of the hollow body of the chamber is advantageously at least equal to the path length of a fission fragment. However, this value depends on the filling gas and its pressure P. Thus, for a given mass of fissile material and a given gas pressure within the optical cavity, the dimensions R and H of the hollow body are advantageously those deduced from the following Equation 3:

$$\{ \begin{matrix}R = \frac{Range ( P )}{2} \\ {m}_{fissile} = 2 π RH {ρ}_{max}\end{matrix} ⇒ \begin{matrix}R = \frac{Range ( P )}{2} \\ H = \frac{{m}_{fissile}}{π Range ( P ) {ρ}_{max}}\end{matrix} \qquad [ Equation 3 ]$$

in which
R is the transverse dimension of the hollow body, i.e. radius in the case of a cylinder,
H is the axial dimension of the hollow body, i.e. length in the case of a cylinder,
Range (P) is the distance that a fission fragment is able to travel through a given gas at a pressure P,
m_{fissile} is the mass of fissile deposit,
ρₘₐₓ is the surface density of the fissile material.

The fissile material is advantageously selected from boron-10, lithium-7, all of the isotopes of uranium-238, plutonium and neptunium.

The material from which the window is made is preferably based on silica. A silica window has a high transmission efficiency and a good radiation resistance. The thickness e determines its ability to withstand the internal pressure of the gas P, as shown by the following Equation 4:

$$e = 1.732 R \sqrt{\frac{P}{{E}_{{SiO}_{2}}}} \qquad [ Equation 4 ]$$

in which E_{SiO2} is the Young's modulus of silica and R is the radius of the window.

The radius R of the window is substantially equal to that of the hollow body.

According to one advantageous variant of embodiment, the optical lens is a Fresnel lens. The advantage of using a Fresnel lens is that it decreases the mass of the material, especially silica, that need be used to manufacture it and therefore decreases the intensity of the

Cherenkov radiation emitted by the optical components (the window and lens). In an optical fibre of numerical aperture NA, the radius of the lens R is that of the window while the thickness of the lens is a characteristic given by the manufacturer.

The focal length f′ of the lens advantageously satisfies the following Equation 5:

$$arctan ( \frac{R}{{f}^{′}} ) < arcsin ( NA ) \qquad [ Equation 5 ]$$

Preferably, the gas filling the optical cavity is advantageously a noble gas, selected from helium, neon, argon, krypton, xenon or a mixture thereof.

The optical cavity is preferably under pressure, typically a pressure of a few bars.

According to one advantageous embodiment, the detector comprises at least one spacer arranged between the window and the hollow body and/or between the mirror and the hollow body. Each spacer plays the role of a physical separator between the deposit of fissile material and one of the optical components (mirror or window), to prevent the latter from clouding prematurely as a result of the impact of fission fragments.

The axial dimension of the spacer is preferably greater than or equal to the path length through the gas of the optical cavity of the light fission fragment (LFF) or ion of maximum range in the gas. LFFs are emitted following interaction of a neutron with an atom of the fissile deposit. Two fission fragments are emitted by fission but only the light one is taken into account when setting dimensions. In the case of fission of uranium-235, the LFF may be likened to a particle of atomic mass A=95 with an initial kinetic energy E=100 MeV.

Specifically, the path length of the LFF is always longer than the path length of other fission products. To increase collection efficiency, the inner surfaces of the spacers are preferably polished to permit reflection of light.

The radius of the spacer is equal to that of the hollow body of the OFC.

Table 2 below gives the path length of the LFF in an optical cavity filled with various noble gases at a pressure of 1 and 5 bar.

TABLE 2

| | |
|---|---|
| Gas | Height H1 or H2 of a spacer (mm) |

| | | |
|---|---|---|
| Pressure (bar) | 1 bar | 5 bar |
| Helium | 128 | 25.1 |
| Neon | 42.7 | 9.45 |
| Argon | 23 | 4.62 |
| Krypton | 17.2 | 3.47 |

It should be clear from Table 2 that it is preferable to use a gas of high atomic number to decrease spacer height and to improve the collection efficiency of the OFC.

According to an advantageous variant of construction, the detection head is fastened, and preferably screwed, to the hollow body of the chamber. The neutron detector is a single object, which may be compact and easily handled.

Thus, the invention essentially consists of a neutron detector comprising a seal-tight optical fission chamber (OFC) and an optical cavity the operation of which is based on optical transduction and which incorporates, at one of its longitudinal ends, a window and an optical lens by way of optical interface and, at the other end, a mirror for reflecting photons travelling away from the window.

A fibre-optic coupler is judiciously positioned in the focal plane of the lens so as to increase, from the exit of the lens, the collection area of the emitted signal without permanently increasing the volume of optical fibres under irradiation, which is a source of noise as a result of Cherenkov radiation.

The deposit of the reflective layer forming the mirror is preferably tailored to the measurement wavelength. Specifically, the coefficients of reflection of light depend on the wavelength of the incident photon. In addition, the most common substrate material, NBK-7, must be avoided. Specifically, it contains B10 which, via (n,α)-reaction, would lead to premature deterioration of the mirror: [9]. As regards the reflective layer, materials such as silver and gold are preferred for their reflectance, which is high and remains constant over a wide range of wavelengths, and in particular in the near infrared.

The window and the optical lens are joined by bonding or integrally formed into a one-piece part, so that these two optical components bear mechanical stress together. Thus, the thickness of the lens makes it possible to apply a proportion of any mechanical stress thereto and to thin the window. The mass of irradiated silica may therefore be decreased, this decreasing noise due to Cherenkov radiation being emitted into these optical components.

A neutron detector according to the invention with miniaturized dimensions may be configured so as to withstand high-temperature, high-radiation environments like those found inside an operating nuclear reactor.

In the end, a detector according to the invention makes it possible to obtain an excellent signal-to-noise ratio when measuring neutron flux.

The invention has many applications, among which mention may be made of the following:
on-line measurement of neutron flux in a nuclear reactor;
characterization and monitoring of neutron flux elsewhere than in a nuclear reactor (experimental reactor or a power-generating reactor);
location of melted fuel elements during or after a serious incident (loss of cooling or even temporary loss of power);
location of, in particular colloidal plutonium, encapsulation stoppers in chemical treatment processes.
neutron measurement on neutron beams for beam-stability purposes or indeed for the purposes of measuring time of flight on these same lines.

Other advantages and features will become more clearly apparent on reading the detailed but non-limiting description, which is given by way of illustration, with reference to the following figures.

### BRIEF DESCRIPTION OF THE DRAWINGS

FIG. 1 is a schematic view in longitudinal cross section of a fission-chamber neutron detector according to the prior art.

FIG. 2 is a schematic view illustrating the principle of luminescence produced by the ionization of a gas by an ionizing particle, most commonly called a heavy ion, arising from the reaction between a neutron and an active material.

FIG. 3 is a view in longitudinal cross section of a neutron detector comprising an optical fission chamber (OFC) and a fibre-optic coupler according to the invention.

FIG. 4 illustrates, in the form of a curve, the result of computation of the angular distribution g(θ) of photons passing through the surface of the window of a neutron detector according to the invention, and dimensioned with components as in FIG. 3.

FIG. 5 is a view in longitudinal cross section of a neutron detector comprising an optical fission chamber (OFC) by way of comparative example.

FIG. 6 illustrates, in the form of a curve, the result of computations of the angular distribution g(θ) of photons passing through the surface of the window of a neutron detector given by way of comparative example, and dimensioned with components as in FIG. 5.

FIG. 7 is a front view of a radiation chamber showing various advantageous positions of installation of a neutron detector comprising an optical fission chamber according to the invention, in the context of irradiation in a nuclear reactor.

FIG. 8 illustrates, in the form of a three-dimensional curve, the collection efficiency obtained as a function of the focal length of the optical lens and of the distance between the optical lens and the fibre by way of output for the signal transmitted by the lens.

FIG. 9 illustrates, in the form of straight lines, the signal-to-noise ratio obtained using a fibre-optic coupler, as a function of the number of optical fibres in the coupler and of the length ratio of coupled and uncoupled fibres, in a neutron detector according to the invention.

FIG. 10 illustrates the distribution and energy level of the signal deposited in the detector as a function of its position along the longitudinal axis X of the neutron detector having the dimensions of the device of FIG. 5.

### DETAILED DESCRIPTION

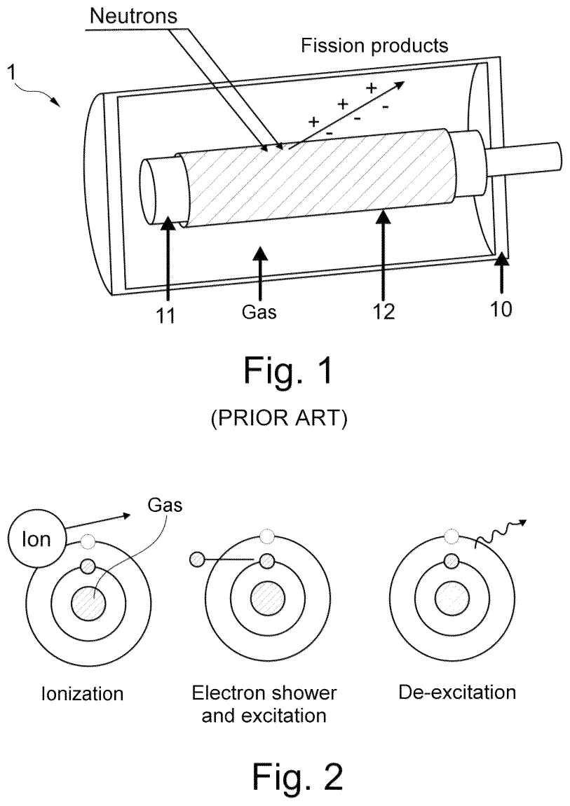

FIGS. 1 and 2 have already been described in the preamble. They will therefore not be discussed below.

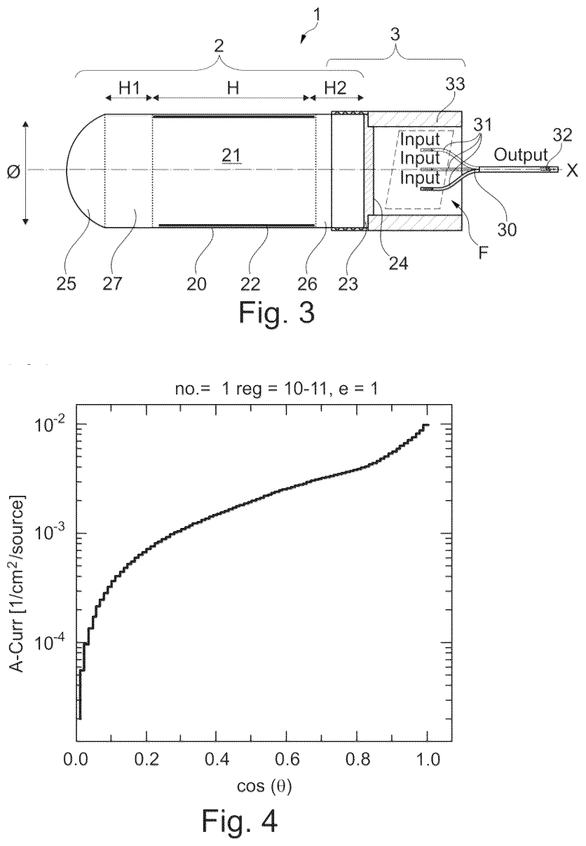

FIG. 3 shows a neutron detector 1 according to the invention.

It firstly comprises a seal-tight ionization chamber 2 in which optical transduction occurs, which chamber is called an OFC, acronym of optical fission chamber, and which chamber extends around a central axis (X).

The OFC 2 comprises a seal-tight hollow cylinder 20, of length H and of diameter ø equal to 2R, bounding internally an optical cavity 21.

The inner wall 22 of the body is coated with a layer of fissile material such as uranium-235, uranium-238 or boron-10.

The optical cavity 21 is filled with at least one noble gas which is preferably under pressure P, and which is capable of being ionized by an ion resulting from a reaction between a neutron and the fissile material. The gas may be selected from helium, neon, argon, krypton, xenon or a mixture thereof.

A window 23 is arranged at one of the longitudinal ends of the hollow body 20 and configured to seal the optical cavity. In addition, a spacer 26 is arranged between the window 23 and the hollow body 20 to prevent the window 23 from clouding prematurely as a result of the impact of fission fragments.

An optical lens 24, preferably a Fresnel lens, is fastened by bonding to or integrally formed with the window, the optical lens being configured to focus photons received by the window 23.

A mirror 25 is arranged at the other of the longitudinal ends of the hollow body, which end is opposite the longitudinal end where the window is arranged. This mirror 25 is configured to reflect photons towards the window. Furthermore, a spacer 27 is arranged between the mirror 25 and the hollow body 20 to prevent the mirror 25 from clouding prematurely as a result of the impact of fission fragments. The spacer 26 and the spacer 27 have a diameter ø equal to that of the hollow cylinder 20. They may be identical to each other, with an axial dimension H1 equal to H2.

The neutron detector 1 further comprises a detection head 3.

This head 3 comprises a fibre-optic coupler 30 comprising a plurality of optical fibres 31 by way of inputs, said optical fibres being arranged in the focal plane F of the lens 24, and a single optical fibre 32 by way of output, in which optical fibre the optical signals received by the inputs are summed.

The inventor has set various dimensions and performed various computations, in particular using the software package known by the acronym PHITS (which stands for Particle and Heavy-Ion Transport code System). This software is an MCNP simulator (MCNP standing for Monte Carlo N-Particle Transport) i.e. is a numerical-simulation software platform using the Monte Carlo method to model nuclear physics processes. This general purpose PHITS software package was developed in the context of a collaboration between the Japan Atomic Energy Agency (JAEA) and a number of other institutes around the world.

To validate the geometry with the various components, especially the optical ones, of the neutron detector 1 according to the invention shown in FIG. 3, the inventor compared this geometry with the geometry of an OFC detector 1′ that was used as a prototype in the laboratory.

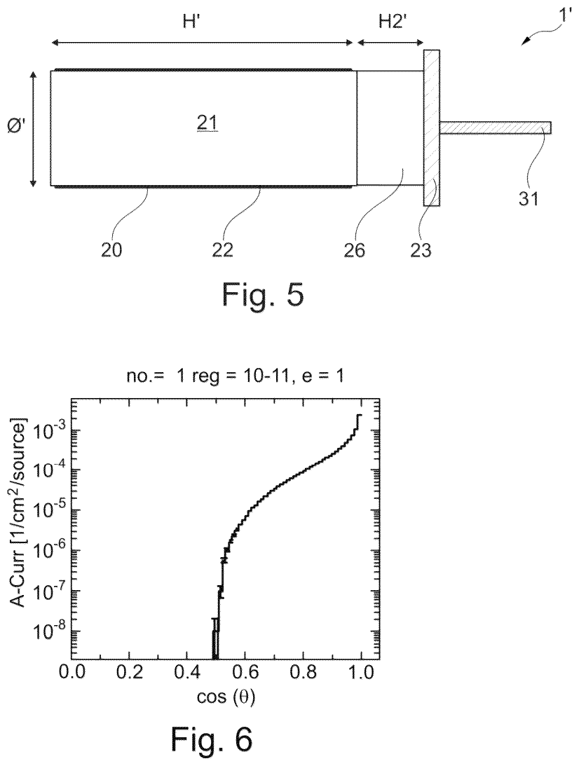

Such a detector 1′ is schematically shown in FIG. 5: it comprises no mirror, optical lens or fibre-optic coupler. Indeed, this detector 1′ comprises only a window 23, spaced apart from the hollow cylindrical body 20 bounding the chamber 21 by a spacer 26.

A single optical fibre 31 is attached directly against the window 23, along the X-axis

To quantify the impact of an optical focusing system, the angular and radial distributions on the surface of the window 23 were computed for the geometry of the neutron detector 1 according to FIG. 3 and, by way of comparative example, for the geometry of the neutron detector 1′ according to FIG. 5.

The graphs of FIGS. 4 and 6 show the results of computations of the angular distribution g(θ) of the photons passing through the surface of the window 23 for the neutron detector 1 and for the neutron detector 1′, respectively. These computations were performed using the software package PHITS.

It will be noted that, in these two detectors 1, 1′, the light source is modelled as being uniform, extended and isotropic.

The dimensions of the detectors 1, 1′ considered are given in Table 3 below.

TABLE 3

| | According to the invention | | Comparative example | |
|---|---|---|---|---|
| Neutron detector | (FIG. 3) | | (FIG. 5) | |
| Height of hollow | H = 12.6 | mm | H′ = 55 | mm |
| body 20 | | | | |
| Height of spacer | H1 = H2 = 5.1 | mm | H2′ = 11.5 | mm |
| 26, 27 | | | | |
| Diameter of hollow | Ø = 12.6 | mm | Ø′ = 7.2 | mm |
| body 20 | | | | |

On assessing the results, it may be seen that by modifying the geometry of the hollow body 20 of the OFC chamber and by adding a mirror 25, the proportion of photons passing through the surface of the window (P_{window}) increases by a factor of 25. This value is underestimated since it does not take into account the improvement due to reflection of photons from the polished walls.

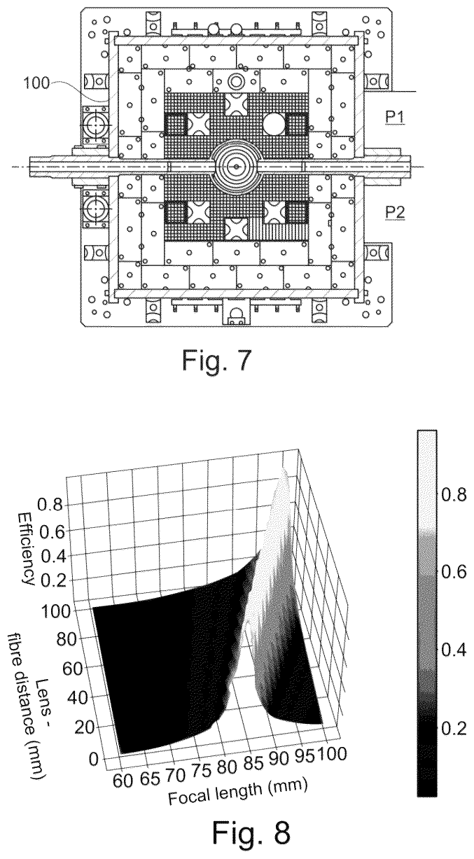

FIG. 7 illustrates advantageous installation in two positions P1, P2 of two neutron detectors 1 as shown in FIG. 3, the neutron detectors being attached to a reflector 100 inside a radiation chamber in a nuclear reactor.

Since the radial and angular distributions of the photons impacting the window 23 are known, it is possible, by virtue of ray transfer matrix analysis, to deduce the same distributions at the exit of the window and, therefore, the resulting collection efficiency. This model assumes that the paraxial approximation is valid, i.e. that the angle of the incident rays is small. This is the case for more than 60% of photons in the case of an OFC detector 1 with the optimized dimensions indicated above.

The inventor compared three neutron detectors with different optical components, namely:
a neutron detector 1′ with a single sealing window as shown in FIG. 5,
a neutron detector 1 according to the invention with a window 23 and a thick optical lens 24 attached as shown in FIG. 3, and
a neutron detector 1 according to the invention with a window 23 and a Fresnel lens 24 attached as shown in FIG. 3.

The transfer matrices for each of these three detectors have been given in Table 4 below.

In Table 4:
L is the distance between the optical component(s) (window with or without an optical lens) and the optical fibre,
R is the radius of curvature of the thick lens,
f′ the focal length of the Fresnel lens,
t is the thickness of the window and that the thick lens set equal to 2 mm,
n₁ is the refractive index of air,
n₂ is the refractive index of silica,
θ and r are drawn randomly in the distributions computed by the PHITS software package.

TABLE 4

| Optical | |
|---|---|
| component(s) | Transfer matrix |
| Window only | $( \begin{matrix}{r}_{2} \\ {θ}_{2}\end{matrix} ) = ( \begin{matrix}1 & L \\ 0 & 1\end{matrix} ) ( \begin{matrix}1 & t \\ 0 & 1\end{matrix} ) ( \begin{matrix}1 & 0 \\ 0 & \frac{{n}_{1}}{{n}_{2}}\end{matrix} ) ( \begin{matrix}{r}_{1} \\ {θ}_{1}\end{matrix} )$ |
| Window with thick optical lens | $( \begin{matrix}{r}_{2} \\ {θ}_{2}\end{matrix} ) = ( \begin{matrix}1 & L \\ 0 & 1\end{matrix} ) ( \begin{matrix}1 & 0 \\ \frac{{n}_{2} - {n}_{1}}{{Rn}_{1}} & \frac{{n}_{2}}{{n}_{1}}\end{matrix} ) ( \begin{matrix}1 & t \\ 0 & 1\end{matrix} ) ( \begin{matrix}1 & 0 \\ \frac{{n}_{1} - {n}_{2}}{{Rn}_{2}} & \frac{{n}_{1}}{{n}_{2}}\end{matrix} ) ( \begin{matrix}{r}_{1} \\ {θ}_{1}\end{matrix} )$ |
| Window with Fresnel lens | $( \begin{matrix}{r}_{2} \\ {θ}_{2}\end{matrix} ) = ( \begin{matrix}1 & L \\ 0 & 1\end{matrix} ) ( \begin{matrix}1 & 0 \\ \frac{- 1}{\text{?}} & 1\end{matrix} ) ( \begin{matrix}1 & t \\ 0 & 1\end{matrix} ) ( \begin{matrix}1 & 0 \\ 0 & \frac{{n}_{1}}{{n}_{2}}\end{matrix} ) ( \begin{matrix}{r}_{1} \\ {θ}_{1}\end{matrix} )$ |

$\text{?} \text{indicates text missing or illegible when filed}$

Computation simulation indicates that the collection efficiency for a single window is lower than with a combined window-optical lens optical system, this making sense given that its acceptance cone occupies only a small fraction of the emission volume.

The computations indicate an increase in collection efficiency by a factor equal to 1.01 for an optical system combining a window and thick optical lens, and equal to 25 for an optical system combining a window and Fresnel lens.

With an optical system combining a window and optical lens, the focal length and the lens-fibre distance may be varied.

The sensitivity profiles of the efficiency clearly show that, for the optical system combining a window and lens, the maximum efficiency is achieved when the optical fibre is placed at the image focal point F of the lens.

In contrast, when using a non-thinned lens, the collection efficiency drops by 40%.

FIG. 8 illustrates the collection efficiency for an optical system combining a window and Fresnel lens.

The inventor has verified the effect of the fibre-optic coupler 30 and optimized it in respect of two parameters, namely the number of optical fibres to be coupled and the ratio x of the length of optical fibre after coupling to the length of optical fibre before coupling.

Given the radii of curvature of the optical fibres, which must not be too great, the inventor considers x to be able to vary between 0.2 and 0.8.

By comparing a neutron detector according to the invention, i.e. with a fibre-optic coupler, with a detector without a coupler, the inventor computed the variations in signal δs and noise δb described in Equation 6 as follows:

$$\frac{δ b}{b} = N ( 1 - x ) + x - 1 \frac{δ s}{s} = N - 1 \qquad [ Equation 6 ]$$

in which N is the number of optical fibres through which light enters the coupler.

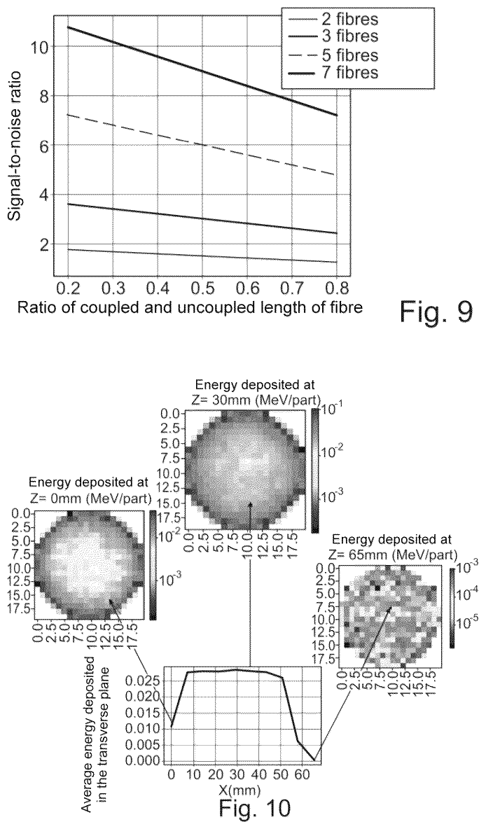

The variation in the signal-to-noise ratio obtained with a fibre-optic coupler according to the invention is shown in FIG. 9.

Thus, computation simulation has allowed the advantage of the presence of the various optical components and fibre-optic coupler in an OFC neutron detector 1 to be justified since they make it possible to maximize the light intensity of the image of the optical source.

FIG. 10 shows the axial and radial distributions of the energy of an optical source through a neutron detector 1 according to the invention.

The shape of this optical source depends on a number of parameters, such as the geometry of the optical cavity, its filling gas, the pressure of the filling gas and the nature of the fissile material, which is selected from uranium-235, boron-10, lithium-7, etc.

The complexity of the optical source combined with the optical components of the detector 1 makes it impossible to compute the image of the source. Since the image of the source in the detection plane F is unknown, the multiple optical fibres positioned as they are make it possible to ensure the places where the image of the source is brightest are occupied. This additional degree of freedom makes it possible to further optimize light collection and therefore to improve the signal-to-noise ratio.

The OFC neutron detector 1 that has just been described has a signal collection efficiency and a signal-to-noise ratio tens of times higher than a prior-art OFC detector.

As may be seen from the above, this improvement is a result of the choice of judiciously added optical components (mirror, window and optical lens), of the fibre-optic coupler, of optimization of their geometry, and of parameters such as the number of optical fibres through which light enters the coupler and the ratio of coupled and uncoupled lengths of fibre.

It goes without saying that the results of the preliminary analyses, which were carried out using the PHITS software package, may be found using specialist optical-computation codes.

Other variants and improvements may be envisaged without however departing from the scope of the invention.

### LIST OF CITED REFERENCES

[1]: M. Lamotte, G. De Izarra, C. Jammes, “Heavy-ions induced scintillation experiments,” J. Instrum., 14 (09) (2019), p. C09024, https://doi.org/10.1088/1748-0221/14/09/C09024
[2]: M. Lamotte, G. De Izarra, C. Jammes, “Development and first use of an experimental device for fission-induced spectrometry applied to neutron flux monitoring”, Nucl. Instrum. Methods Phys. Res. A953 (2020), p. 163236, https://doi.org/10.1016/j.nima.2019.163236.
[3]: M. Lamotte, G. De Izarra, C. Jammes, “Design and irradiation test of an innovative optical ionization chamber technology”, Nucl. Instrum. Methods Phys. Res. A968 (2020), p.163945, https://doi.org/10.1016j.nima.2020.163945.
[4]: M. Lamotte, G. De Izarra, C. Jammes, SCENA: “A simulation tool for radiation-induced gas scintillation”, Nucl. Instrum. Methods Phys. Res. A982 (2020), p. 164576, https://doi.org/10.1016/j.nima.2020.164576.
[5]: Cheymol G., Long H., Villard J.-F., Brichard B., “High level gamma and neutron irradiation of silica optical fibers in CEA OSIRIS nuclear reactor”, IEEE Trans. Nucl. Sci., 55 (4) (2008), pp. 2252-2258.
[6]: Goburnov, B., “Perspectives d'utilisation de convertisseurs optiques nucléaires pour l'enregistrement de flux de photons dans les réacteurs nucléaires” [Prospects of using nuclear optical converters to record photon flux in nuclear reactors]. Russian Federal Nuclear Centre. (2015).
[7]: Lamotte, M., “Etude du signal optique des chambres à fission et évaluation de son exploitation pour un système de mesure neutronique d'un réacteur de génération IV” [Study of the optical signals of fission chambers and evaluation of applicability to a neutron-measuring system for a Generation IV reactor]. Doctoral thesis of the University of Grenoble. (2021).
[8]: Brichard, B. “Fiber-optic gamma-flux monitoring in a fission reactor by means of Cerenkov radiation”. Measuring Science Technology—vol 18, 3257-3262.
[9]: Wirtenson, R. H. “Radiation Induced Darkening of the Optical Element in the Startracker camera. ” Technical report of Lawrence Livermore National Laboratory. (2007).

1. A neutron detector comprising:
at least one seal-tight ionization chamber in which optical transduction occurs, which chamber is called an OFC, acronym of optical fission chamber, each chamber extending along a longitudinal axis (X) and comprising:
a seal-tight hollow body bounding internally an optical cavity and comprising at least one inner wall coated at least partially with at least one layer of fissile material, the optical cavity being filled with a gas and which is capable of being ionized by an ion resulting from a reaction between a neutron and the fissile material,
a window, arranged at one of the longitudinal ends of the hollow body and configured to seal the optical cavity,
an optical lens, fastened by bonding to or integrally formed with the window, the optical lens being configured to focus photons received by the window,
a mirror, arranged at the other of the longitudinal ends of the hollow body, which end is opposite the longitudinal end where the window is arranged, the mirror being configured to reflect photons towards the window,
a detection head comprising a fibre-optic coupler comprising a plurality of optical fibres by way of inputs, said optical fibres being arranged in the focal plane of the lens, and one optical fibre by way of output, in which optical fibre the optical signals received by the inputs are summed.

2. The neutron detector according to claim 1, wherein the OFC is axisymmetric in shape and having a central axis (X) corresponding to the axis of longitudinal extension of the ionization chamber.

3. The neutron detector according to claim 2, wherein the hollow body of the OFC is a cylinder, a sphere or a cone.

4. The neutron detector according to claim 1, wherein the surface density ρmax of the fissile material is less than or equal to 2 mg/cm².

5. The neutron detector according to claim 1, wherein the fissile material is selected from boron-10, lithium-7, isotopes of uranium-238, plutonium and neptunium.

6. The neutron detector according to claim 1, wherein the gas is selected from helium, neon, argon, krypton, xenon or a mixture thereof.

7. The neutron detector according to claim 1, wherein the material from which the window is made, is based on silica.

8. The neutron detector according claim 1, wherein the optical lens is a Fresnel lens.

9. The neutron detector according to claim 1, comprising at least one spacer arranged between the window and the hollow body and/or at least one spacer arranged between the mirror and the hollow body.

10. The neutron detector according to claim 9, wherein the axial dimension of the spacer is greater than or equal to the path length through the gas of the optical cavity of the light fission fragment (LFF).

11. The neutron detector according to claim 1, wherein the detection head is fastened to the hollow body of the chamber.

12. Use of a device for detecting neutrons according to claim 1 to characterize and track neutron flux in a nuclear reactor.

13. Use of a device for detecting neutrons according to claim 1 to locate melted fuel elements during or after a serious incident, such as a loss of cooling or a temporary loss of power.

14. Use of a device for detecting neutrons according to claim 1 to locate, in particular colloidal plutonium, encapsulation stoppers in chemical treatment processes.
